(19) United States
(12) Patent Application Publication
(10) Pub. No.: US 2009/0321154 A1
(43) Pub. Date: Dec. 31, 2009

(54) HYDRAULIC SYSTEM HAVING MANIFOLD WITH REMOTE CONTROL FOR GRAIN CART

(76) Inventor: Michael R. Johnson, Little Rock, IA (US)

Correspondence Address: DORSEY & WHITNEY LLP;INTELLECTUAL PROPERTY DEPARTMENT, 801 GRAND, SUITE 3900, DES MOINES, IA, 50309, US

(21) Appl. No.: 12/164,944

(22) Filed: Jun. 30, 2008

(51) Int. Cl. B60K 25/00; B60P 1/40

(52) U.S. Cl. 180/53.4; 414/526; 414/519

(57) ABSTRACT

A grain cart is provided having a plurality of moveable devices positioned thereon which are hydraulically controlled. A manifold is mounted to the grain cart and hydraulically connected to more than one of the plurality of moveable devices. A remote control is provided in communication with the manifold to hydraulically control movement of the moveable devices hydraulically connected to the manifold. A remote control for controlling functions of a grain cart and a method of assembling of a control assembly are also disclosed.

### SCOPE OF THE INVENTION

The present invention relates to agricultural implements, and in particular, the control of hydraulic components of a grain cart.

### BACKGROUND

Agricultural implements, and in particular grain carts are known and generally include one or more hydraulically operated or controlled components.

Hydraulic systems are often used on such grain carts or agricultural implements to control moveable components or parts, particularly where a large load must be overcome. Generally, hydraulic systems include oil that may flow and transmit power. Hydraulic oil or fluid is typically contained in a reservoir mounted to the implement or device. Hoses are used to direct the hydraulic fluid to the appropriate locations, and typically include low pressure hoses, high pressure hoses or lines, and rigid style hoses. From the reservoir the hydraulic fluid flows through a low-pressure hose to a pump which may be powered by a number of sources. For example, a tractor will often include an internal drive running a pump mounting in the transmission casing that runs for example, the three point hitch.

In operation, a standard grain cart generally requires or includes three hydraulic remotes or levers. That is, each hydraulic dimension requires a lever or control to operate the particular function. An additional hydraulic control may be used to control a hydraulic unloading drive. When a lever is actuated, the hydraulic fluid flows into the now opened circuit of choice, usually to a hydraulic cylinder performing some function. As the hydraulic fluid flows under pressure to one side of the selected cylinder the ram extends or retracts depending on the selection. Hydraulic fluid from the other side of the cylinder flows back through its high-pressure hose and back to the reservoir. When the spool-actuating lever is pulled the other direction, the process is reversed and the hydraulic cylinder actuates in the opposite direction. A spring detent keeps the shifting lever in a neutral position when not in use.

Unfortunately, the foregoing systems suffer several drawbacks. Typically, the hydraulic levers are mounted within the tractor cab. Each function of the agricultural implement, namely, the grain cart, requires a separate lever for its function. As a result, a set of hydraulic lines for each functional component extend from the grain cart to the tractor, causing difficulty in hook-up and exposure of the hydraulic lines to possible damage. Secondly, the hydraulic levers are commonly mounted such that the operator must turn away from the view of the grain cart to operate the control or turn away from the controls, making it difficult to monitor the position of the moveable components and creating an unsafe operating environment. Third, the control levers are generally not labeled, so that an operator must use trial and error to determine the appropriate function he or she wishes to select.

Accordingly, what is needed is a control system and hydraulic assembly that among other features, enhances the ease of operation and assembly.

### SUMMARY OF THE INVENTION

A grain cart is provided having a plurality of moveable devices positioned thereon which are hydraulically controlled. A manifold is mounted on the grain cart and in hydraulic communication with more than one of the plurality of moveable devices. A remote control is provided in communication with the manifold to hydraulically control movement of the moveable devices hydraulically connected to the manifold.

A remote control for controlling functions of a grain cart is also provided. The remote control has a control interface with a plurality of control elements and a communication means for communicating with a manifold carried by the grain cart, which manifold is hydraulically connected to a plurality of moveable devices carried by the grain cart. The moveable devices are controlled in response to the operation of at least one control element.

A method of assembling a control assembly for a grain cart is also provided. In the method, a grain cart having a plurality of moveable devices is obtained. A manifold is attached to the grain cart. Hydraulic lines are connected between the manifold and the plurality of moveable devices. A single hydraulic supply line is connected between the manifold and the towing vehicle and a single hydraulic return line is connected between the manifold and a towing vehicle. A communication means is placed in communication with the manifold for control of the plurality of moveable devices.

The present invention has significant advantages over traditional devices. The remote control of the operations enhances user safety and comfort in control of the features of the grain cart as the user may hold the remote control in hand and simultaneously operate the control and view the operation of the device. Furthermore, only a single set of hydraulic lines are provided between the towing vehicle and the grain cart, providing ease of hook up and operation of the cart. Moreover, the central operation and control of the various functions of the grain cart stemming from a single position on the grain cart, and by use of a single controller, reduces the number of components in a hydraulic system and steps that must be taken by an operator to operate the moveable devices connected to the hydraulic system. Other advantages and features may become apparent from the following description, drawings, and claims.

### BRIEF DESCRIPTION OF THE DRAWINGS

FIG. 1 is a perspective view of a grain cart according to an embodiment of the present invention.

FIG. 2 is a perspective view of a grain cart of FIG. 1, showing a towing vehicle connected thereto.

FIG. 3 is a cut-away perspective view of the grain cart of FIG. 1, taken from line 3-3 of FIG. 1, showing a portion of the hydraulic assembly on the grain cart.

FIG. 4 is a perspective view of the grain cart of FIG. 1, cut away to show a plurality of hydraulic lines on the grain cart.

FIG. 5 is a cut-away perspective view of a manifold for use with the grain cart of FIG. 1, taken along line 5-5 of FIG. 3, showing the manifold attached to the grain cart and having connected thereto hydraulic lines and a controller communication line.

FIG. 6 is a cut-away perspective view of the grain cart of FIG. 1, taken from line 6-6 of FIG. 1, showing a hydraulic cylinder and hydraulic lines operably connected to the auger assembly.

FIG. 7 is a cut-away perspective view of the grain cart of FIG. 1, taken along line 7-7 of FIG. 4, showing the discharge chute and associated hydraulic lines.

FIG. 8 is a cut-away perspective view of the grain cart of FIG. 1, taken along line 8-8 of FIG. 1, showing the grain bin inner door having an attached hydraulic cylinder with hydraulic lines.

FIG. 9 is a perspective view of a manifold for use with the grain cart of FIG. 1.

FIG. 10 is a schematic diagram of the manifold shown in FIG. 9.

FIG. 11 is an elevational view of a manifold for use with the grain cart of FIG. 1, taken along line 11-11 of FIG. 9.

FIG. 12 is a top plan view of a manifold for use with the grain cart of FIG. 1, taken along line 12-12 of FIG. 11.

FIG. 13 is a side elevational view of a manifold for use with the grain cart of FIG. 1, taken along line 13-13 of FIG. 11.

FIG. 14 is a side elevational view of a manifold for use with the grain cart of FIG. 1, taken along line 14-14 of FIG. 11.

FIG. 15 is a perspective view of a remote control for use with the grain cart of FIG. 1, showing a cable connection and pendant grip.

FIG. 16 is a side perspective view of a remote control for use with the grain cart of FIG. 1, taken along line 16-16 of FIG. 15.

FIG. 17 is a perspective view of an alternative embodiment of a remote control for use with the grain cart of FIG. 1.

FIG. 18 is a perspective view of a receiver for use the grain cart of FIG. 1, showing a wireless receiver for receipt of a signal from a remote control.

### DESCRIPTION OF THE INVENTION

The invention is generally directed to an agricultural implement, and in particular a grain cart having a manifold hydraulically connected to a plurality of moveable components or devices on a grain cart.

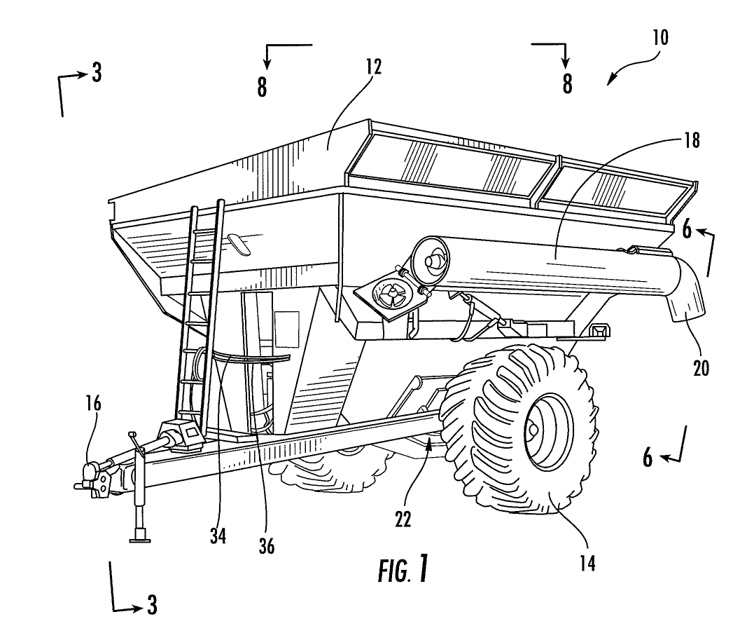

In an exemplary embodiment, the grain cart 10 includes a grain bin 12 for receipt and transport of grain or other material, one or more wheels 14 or track assemblies for movement and a hitch assembly 16. The grain cart 10 shown in FIG. 1 also includes a foldable auger 18, a rotatable chute 20, and a grain bin door 22 (best seen in FIG. 8) each of which may be hydraulically controlled. While an auger 18, chute 20 and door 22 are specifically discussed it is understood that additional hydraulically controlled components or devices may be provided in addition to or in place of the exemplary devices described.

Referring generally to FIGS. 1-5, the grain cart 10 may further include a hydraulic control assembly 24, including a manifold 26, one or more hydraulic lines or hoses, a pump 32 assembly, and a control system, which assembly 24 controls or facilitates movement of certain moveable components of the grain cart 10, and may be used to control a plurality of components. A manifold 26 may be connected to the grain cart 10 for hydraulic control of the functions of the grain cart 10. To this end, the grain cart 10 may have a plurality of hydraulic lines extending from a source to hydraulic cylinders operably connected to each of the moveable components suitable for control by a hydraulic mechanism. Generally, the hydraulic system may include oil that may flow and transmit power. The hydraulic oil or fluid may be contained in a reservoir (not shown) mounted to the grain cart 10 or a tractor 28. Hydraulic lines, which may be hoses, are used to direct the hydraulic fluid to the appropriate locations, and may include any combination of low pressure hoses or lines, high pressure hoses or lines, or rigid style hoses or lines.

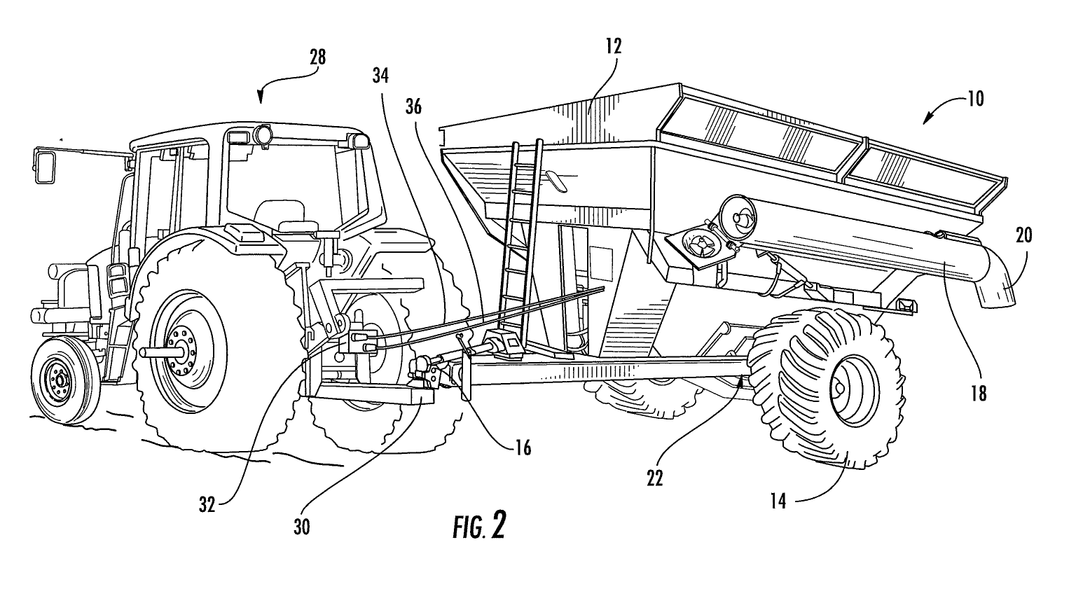

As seen in FIG. 2, a tractor or towing vehicle 28 having a hitch 30 for coupling to the grain cart 10 may be provided with a pump 32 for pumping 32 hydraulic fluid through the system. The pump 32 may be any variety of pump suitable for use with a hydraulic systems, such as, but not limited to, a piston-style, a vane-type pump or a gear-type pump. Likewise, the towing vehicle 28 may be any suitable vehicle capable of pulling the grain cart 10.

In the exemplary embodiment shown in FIGS. 2-5, a supply line 34, formed by a hose or the like, extends from the pump 32 associated with the tractor or towing vehicle 28 to the manifold 26. A return line 36, formed by a hose or the like, may also be provided extending between the manifold 26 and the pump 32.

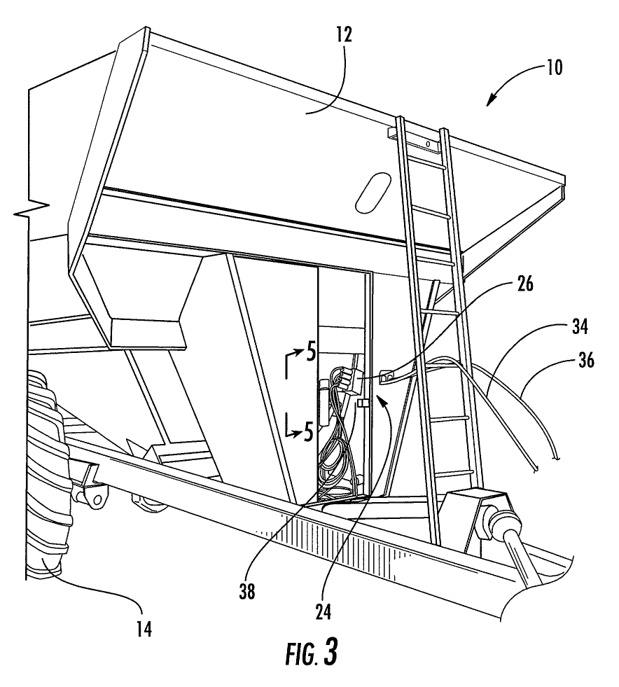

In a preferred embodiment, the manifold 26 is mounted on or near the grain cart 10. As illustrated in FIGS. 3 and 5, the manifold 26 is mounted to a surface 38 of the grain cart 10. More preferably, the manifold 26 is mounted in a location that may be accessible for attachment of hydraulic lines between the towing vehicle 28 and the grain cart 10, and for attachment of hydraulic lines between the manifold 26 and the hydraulic cylinders operably associated with moveable components of the grain cart 10, although any suitable surface of the grain cart 10 may be acceptable for the purposes provided. Further, as shown in FIG. 3, the manifold 26 may be mounted in a protected or semi-protected location of the grain cart 10 to provide a level of protection, which, for example, may help to avoid over-exposure to the elements or damage which may be caused during operation or use of the grain cart 10.

The manifold 26 generally operates to direct the hydraulic fluid supplied from the pump 32. The hydraulic fluid is provided from the pump 32 into the supply line 34, and directed through the manifold 26 to the selected hydraulic cylinder. If nothing is selected, then hydraulic fluid may flows through the manifold 26 into the return line 36 and the reservoir. To this end, in addition to the supply line 34 and return line 36 operably connected to the manifold 26, one or more hydraulic lines may also be operably connected to the manifold 26 for communication with one or more hydraulic cylinders. In the exemplary embodiment of FIG. 5, hydraulic lines are provided in communication with the manifold 26 for communication with three hydraulic cylinders.

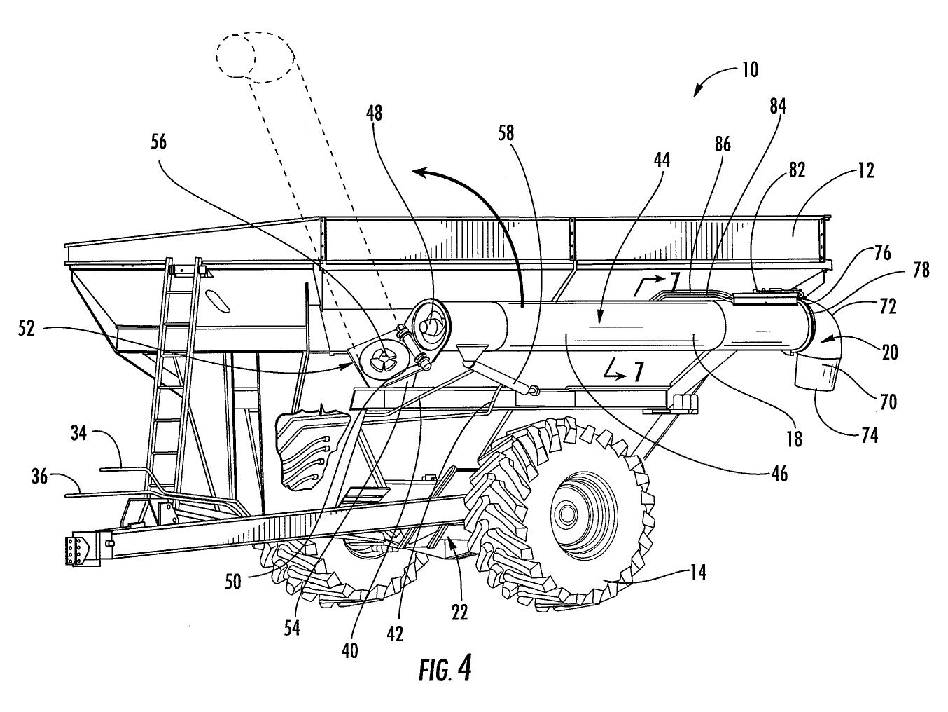

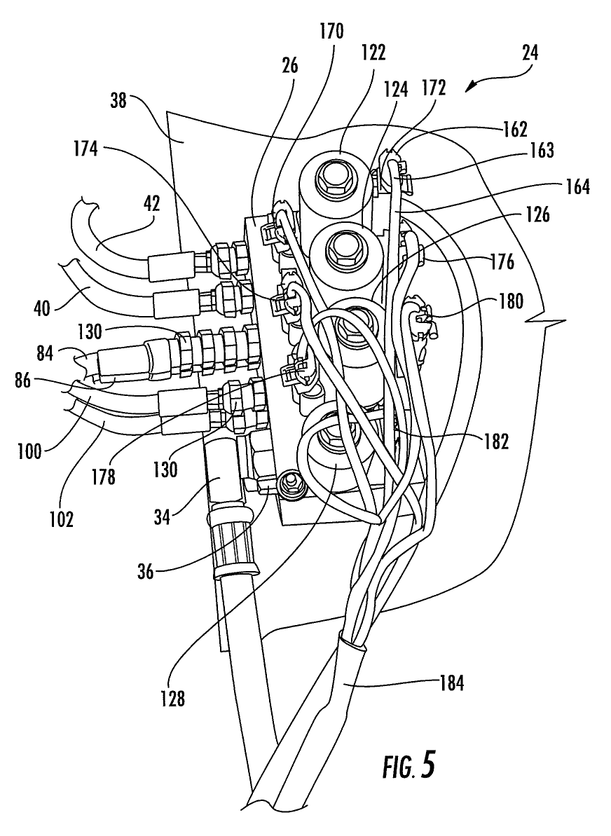

Referring to FIGS. 4-6, one hydraulic line or set of hydraulic lines 40, 42 may be in operable communication between the manifold 26 and an auger 18. As shown in FIG. 6, the auger 18 of the illustrated embodiment is a foldable auger. To this end, the auger 18 has a first portion 44 generally including an auger tube 46 carrying a flighting or auger screw 48 (FIG. 4). The first portion 44 is moveably connected by, for instance, a hinge 50, to a second portion 52 including, generally, a grain cart access port 54 and a drive assembly 56 operably connectable to the flighting 48 for the transmission of material through the auger tube by the flighting. Two hydraulic lines 40, 42 may be connected to a hydraulic cylinder 58 which may be operable to control movement of the auger 18. Specifically, the auger cylinder 58 is provided to fold and unfold the auger 18. The hydraulic auger cylinder 58, on a first end 60, is operably associated with, connected to, or mounted to a portion 61 of the first portion 44 of the auger 18. A second end 62 is operably associated with, connected to, or mounted to a surface 64 of the grain cart 10. The cylinder 58 may be mounted by any suitable means, and is preferably pivotally attached to the auger 18 at one or both locations. The hydraulic auger cylinder 58 is extendable so that extension of the auger cylinder 58 causes the movement of the first portion 44 of the auger 18 about the hinge 50, for example, to extend the auger 18 away from the grain cart 10 (see FIG. 4). Retraction of the auger cylinder 58 causes the movement of the first portion 44 of the auger 18 in the opposite direction. A first hydraulic line 40 is in communication with or may be connected with the auger cylinder 58 at a first portion 66, and a second hydraulic line 42 is in communication with or may be connected with the auger cylinder 58 at a second portion 68. As described herein, hydraulic fluid flow at these locations facilitates the extension or retraction of the cylinder.

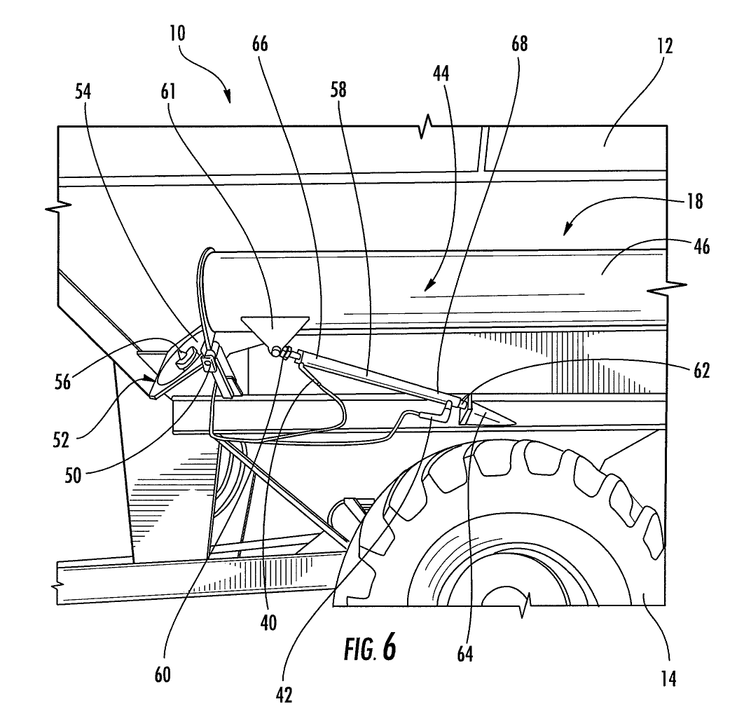

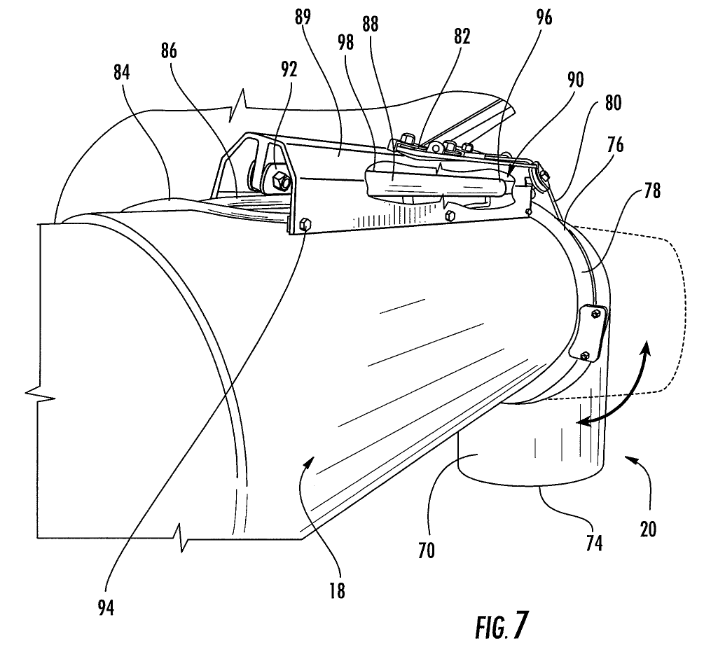

As shown in FIGS. 4 and 7, the auger tube 46 may carry a discharge chute 20. The discharge chute 20 includes a portion 70 for the directional distribution of material from the auger 18. In the illustrated embodiment, portion 70 includes an elbow 72 between the discharge end 74 and an auger communication end 76. At the auger communication end 76 may be a drive ring 78 which provides for the rotational mounting of the discharge chute 20 to the auger 18. To this end, one or more cables 80 may be provided in association with a pulley system 82 including pulleys that may be connected to the drive ring 78 such that movement of a cable 80 through the pulley system 82 in a first direction causes the rotation of the chute 20 in a first direction and movement of the cable 80 in a second direction causes rotation of the chute 20 in a second direction. Referring to FIGS. 4, 5 and 7, one hydraulic line or set of hydraulic lines 84, 86 may also be in operable communication between the manifold 26 and the discharge chute 20. As shown in FIG. 7, two hydraulic lines 84, 86 may be connected to a hydraulic cylinder 88 which may be operable to control movement of the chute 20. The drive ring 78 may be operable communication with the hydraulic chute cylinder 88. More specifically, the cable 80 or pulley system 82 may be further connected to the hydraulic chute cylinder 88 for transmitting motion to the chute 20. The chute cylinder 88 has a first end portion 90 and a second end portion 92, and may be mounted or connected to the auger tube 46 on a surface 94 thereof preferably by a mount 89 which receives the cylinder 88 at its end 92, the other end portion 90 may be operably connected to the pulley system. The cylinder 88 may be mounted by any suitable means, and may include or form one or more pivotal connections. The chute cylinder 88 is preferably extendable such that extension of the hydraulic cylinder 88 transmits motion to the pulley system 82 and cable 80 in a first direction and retraction of the hydraulic cylinder 88 transmits motion in a second, opposite, direction. A first hydraulic line 84 is in communication with or may be connected with the chute cylinder 88 at a first portion 96 and a second hydraulic line 86 may be in communication with or may be connected with the chute cylinder 88 at a second portion 98, such that supply of hydraulic fluid through these lines facilitates extension or retraction of the cylinder 88.

As shown by reference to FIG. 5 and FIG. 8, one hydraulic line or a set of hydraulic lines 100, 102 may also be in operably communication between the manifold 26 and the inner door 22 or grain bin door 22 of the grain cart 10. The inner door 22 may be formed of a door portion 104 which is moveable to cover and uncover an opening (not shown) in the grain cart 10. Preferably, the door portion 104 is slidable along a portion 106 of an inner surface 108 of the bin 12, and may optionally be formed of or include a track or guide assembly to aid in uniform movement of the door 22. The inner door 22 is preferably operably associated with or connected to a door hydraulic cylinder 110. The door cylinder 110 is extendable and has a first end portion 112 and a second end portion 114. The first end portion 112 is attached to, or associated with, the grain bin 12. The second end portion 114 is attached to or in communication with the inner door 22. The cylinder 110 may be mounted by any suitable means, and may form one or more pivotal mountings. Two hydraulic lines 100, 102 may be connected between the manifold 26 and the hydraulic cylinder 110 which may be operable to control movement of the inner door 22. A first hydraulic line 100 is in communication with a first portion 116 of the door cylinder 110 and a second hydraulic line 102 is in communication with a second portion 118 of the cylinder 110. Hydraulic fluid flow through the line facilitates extension or retraction of the cylinder 110. The door cylinder 110 is operable, such that extension of the cylinder 110 moves the door 22 in a first direction and retraction of the cylinder 110 moves the door 22 in a second direction so as to facilitate opening and closing of the door 22.

The auger 18, discharge chute 20, and inner door 22 described herein have been described with a degree of particularity for purposes of explanation. However, additional or alternative components commonly associated with such devices and assemblies may be attached or associated with these assemblies and devices without departing from the overall scope of the present invention.

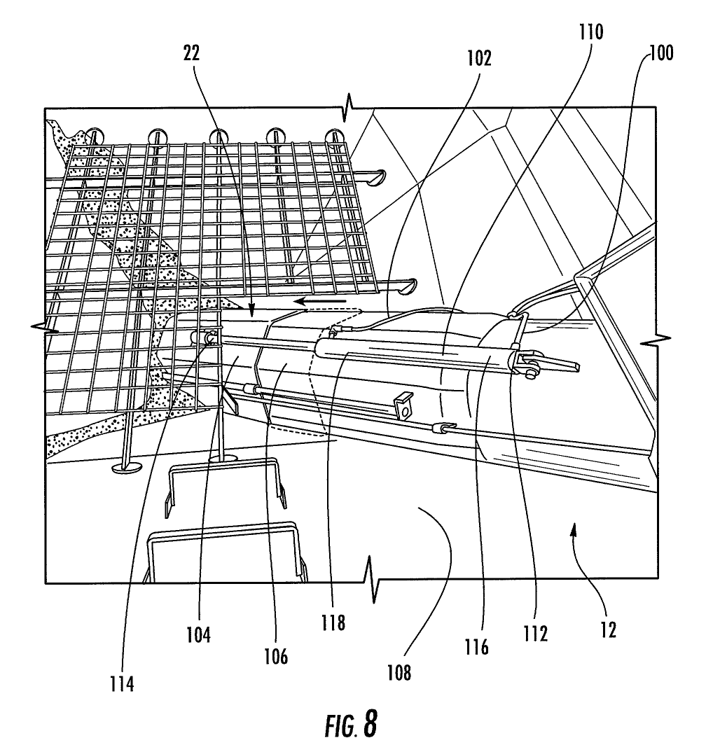

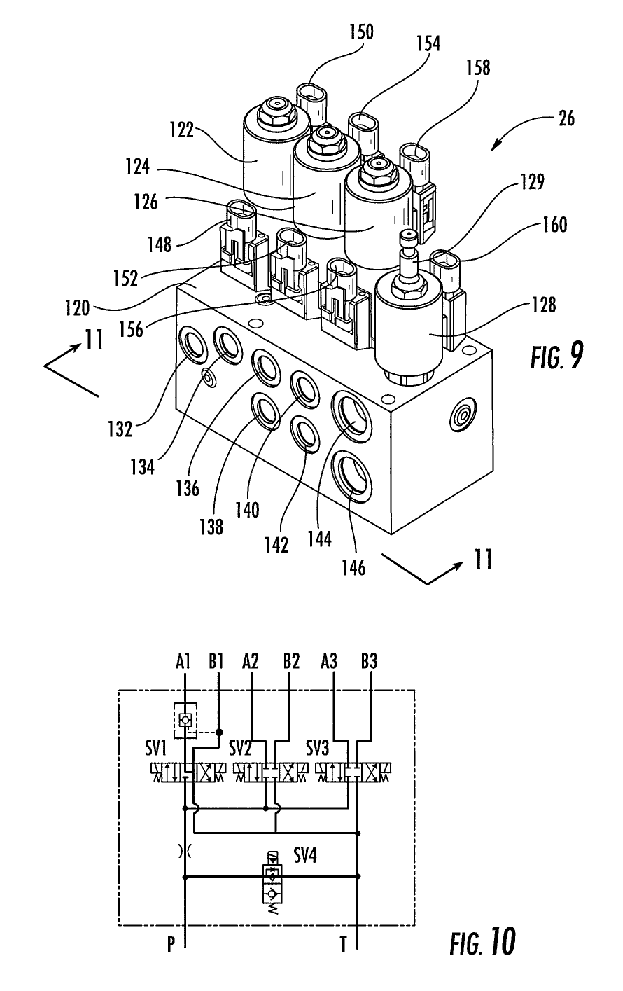

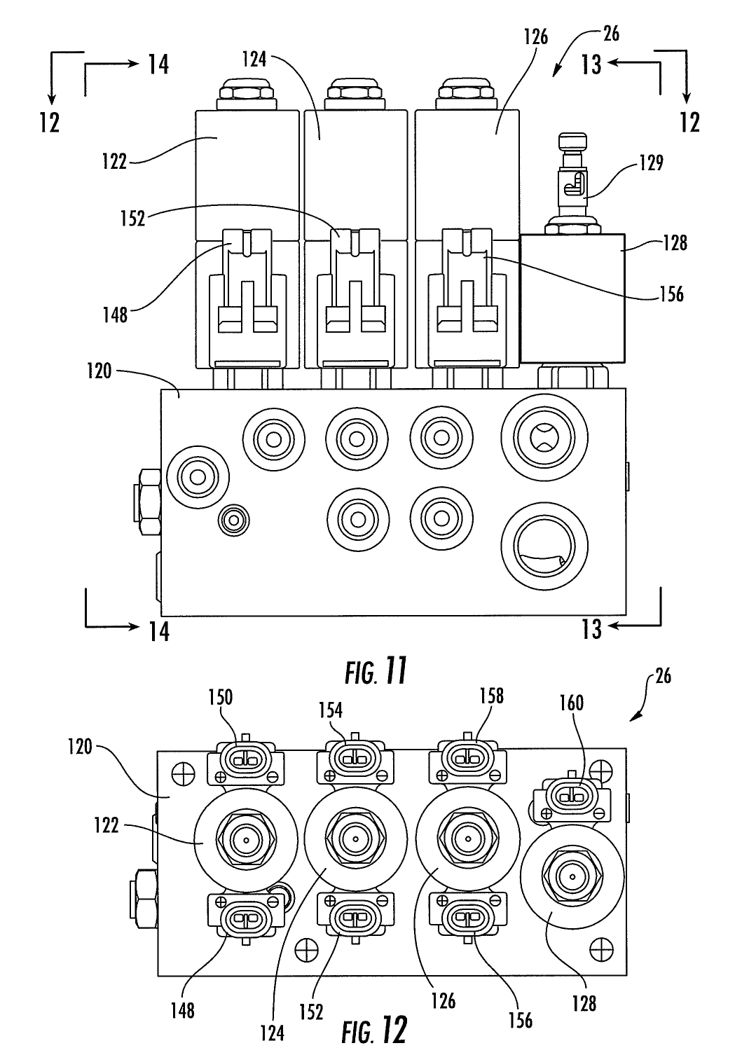

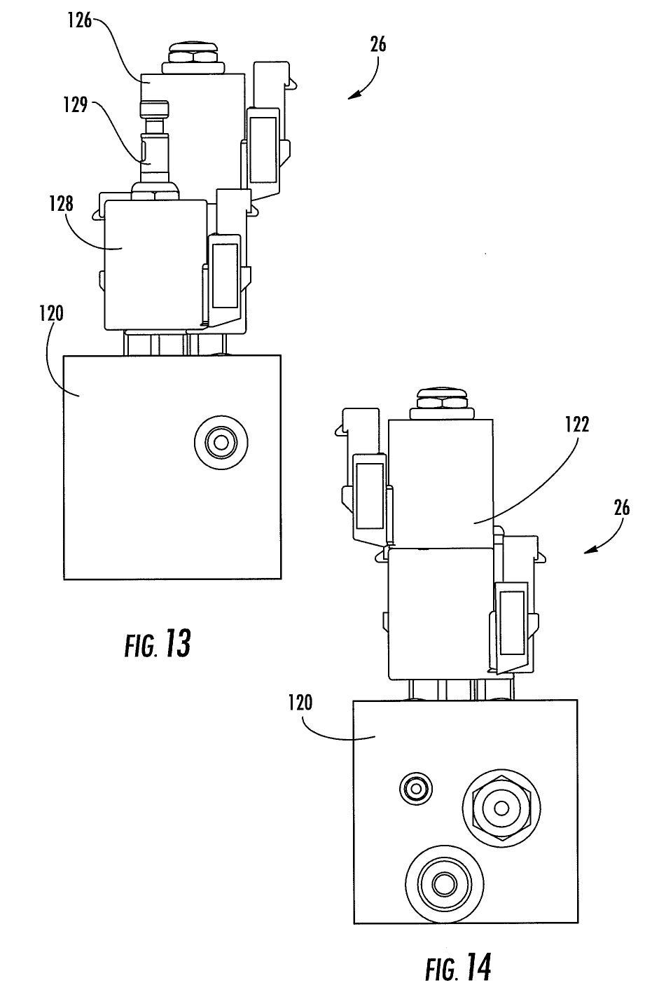

The manifold 26 referring to FIGS. 5 and 9-14, may be generally formed of an assembly including a body 120 having a branch pipe arrangement, and carrying one or more valves, one or more ports or orifices and plugs for communication with the hydraulic lines of the assembly. The manifold 26 is preferably formed of any suitable material, such as but not limited to metal, plastic, composite, and combination thereof, and may preferably be formed of a metal, such as stainless steel or anodized aluminum. An exemplary manifold 26 for use with the present invention may include one or more valves attached to a body 120.

The manifold 26 is in operable communication with a plurality of valves, and carries and engages valves 122, 124, and 126, which may be solenoid valves, for communication with the hydraulic lines of the assembly. (see FIG. 9). Suitable valves may include 3-position, 4-way valves available from Parker-Hannifin Corporation, Lincolnshire, Ill. In addition, the manifold 26 may include valve 128, which may also be a solenoid 2-position, 2-way dump valve for communication with the hydraulic lines associated with the towing vehicle 28. One or more check valves 129 may also be provided on the manifold 26.

Associated with one or more valves, on a surface of the manifold 26, may be one or more ports, and preferably a plurality of ports for engagement with the hydraulic lines. In a preferred embodiment, each valve is provided in communication with at least one and preferably two ports. To this end, valve 122 may be in communication with ports 132 and 134. Valve 124 may be in communication with ports 136 and 138 and valve 126 may be in communication with ports 140 and 142. Likewise, ports 144 and 146 associated with supply and return lines 34, 36 may be in communication with valve 128. The ports may form pathways for hydraulic fluid flow between the pump and the respective cylinder through the manifold. To this end, the hydraulic lines may be provided with a fitting 130 that is adapted to engage a port of the manifold 26 (see FIG. 5). Any suitable port and fitting arrangement may be acceptable for the purposes provided.

Accordingly, hydraulic lines forming the in-feed or supply line 34 and outlet or return line 36, are in communication between the manifold 26 and the towing vehicle 28 (see FIG. 2). The remaining hydraulic lines 40, 42, 84, 86, and 100, 102 are preferably in communication between the manifold 26 including corresponding valve, mounted on the grain cart 10 (see FIG. 5), and the moveable device and it's respective hydraulic cylinder, also carried by the grain cart 10 (see FIGS. 6-8). In particular, hydraulic lines 40 and 42 extend, and form a communication arrangement between the manifold 26 at a first end, and the auger hydraulic cylinder 58 at a second end (see FIG. 6). Hydraulic lines 84 and 86 extend, and form a communication arrangement between the manifold 26 at a first end and the discharge chute hydraulic cylinder 88 at a second end (see FIG. 7). Hydraulic lines 100 and 102 extend, and form a communication arrangement between the manifold 26 at a first end and the inner door hydraulic cylinder 110 at a second end (see FIG. 8).

Each of the valves 122, 124, 126, 128, which in the exemplary embodiment may be solenoid valves, may have one or more electrical ports or electrical interfaces. To this end, valve 122 includes electrical interfaces 148 and 150; valve 124 includes electrical interfaces 152 and 154, and valve 126 includes electrical interfaces 156 and 158. Each electrical interface may be used to supply or convert an electrical signal into a mechanical movement of the valve. Thus, each valve may have a first electrical interface which operates or sends a signal or converts an electrical signal to a mechanical action to open the valve, and a second electrical interface which operates in the same manner to close the valve. Valve 128 in the illustrated embodiment includes a single electrical interface 160 or port which may operate to switch the two way valve connected to the hydraulic supply and return lines 34, 36. While specific interfaces are described additional interfaces or alternative arrangements or interfaces would not depart from the overall scope of the present invention.

The electrical interfaces may be formed of ports for receipt of, or mating with, a plug or jack operably connected to a control, such as a remote control. More specifically, the plug 162 may be attached to a first end 163 of a wire or cable 164 which extends to a second end 166 in communication with or attached to a remote control 168. Each plug 162 and cable 164 is adapted to transmit a signal, such as an electrical signal, to the solenoid to operate or control or engage the valve. While a specific electrical interface and plug arrangement is described, any plug or corresponding electrical interface may be acceptable for purposes of the present invention. As a plurality of electrical interfaces may be provided, one or more of plugs 162 may be provided, and may be provided for each valve so as to mate with a corresponding electrical interface on the valve. Thus, as can be seen in FIG. 5, electrical interfaces may receive mating plugs 162. Each plug 162 and corresponding interface forms an electrical connection. To this end, the remote control provides an arrangement for sending electrical signals to the valves. Thus, (referring to FIG. 5) the first valve 122 is associated with a first electrical connection 170 and a second electrical connection 172, the second valve 124 is associated with a first electrical connection 174 and a second electrical connection 176, and the third valve 126 is associated with a first electrical connection 178 and a second electrical connection 180. The fourth valve 128 may also include an electrical connection 182. The plurality of cables 164 extending from the electrical connections to the remote control 168 may be contained within a sheath 184 or like device.

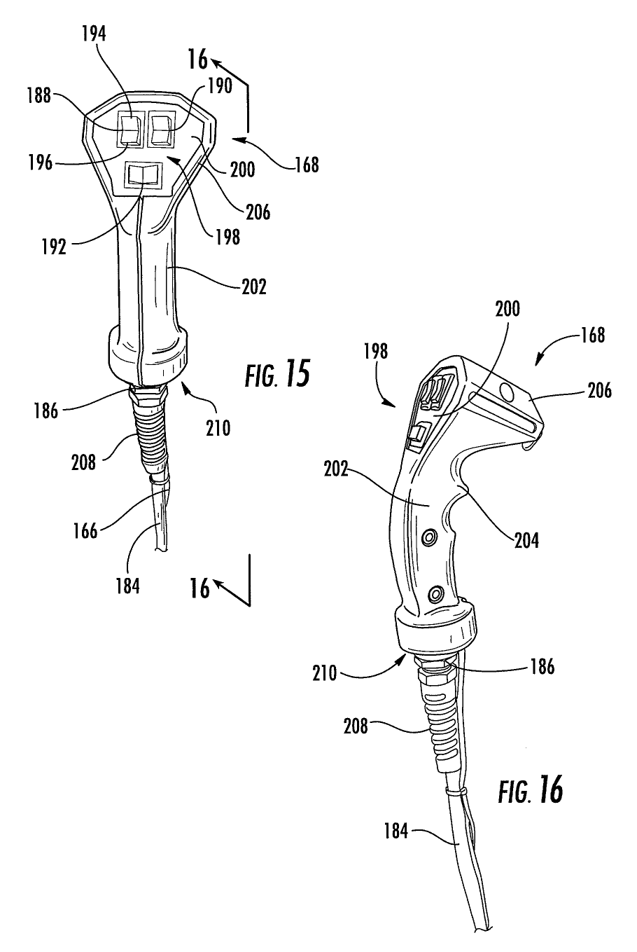

An exemplary remote control 168, shown in FIGS. 15-16, for use with the hydraulic assembly 24 may be a pendant-type control and include a port 186 for receipt of the second end of each cable 164. Preferably, each cable 164 may further be operably connected to one or more controls or control elements 188, 190, 192 of the remote control 168. The control elements 188, 190, 192 are adapted to control one or more functions of the grain cart 10. In a preferred embodiment, control elements 188, 190, 192 are provided in the form of buttons or rocker switches that may be depressed for activation of a particular function. For instance, the remote control 168 illustrated in FIGS. 15-16 includes three rocker switches on a control interface 198. Each rocker switch is adapted to control a different function of the grain cart 10. In the illustrated example, a first rocker switch may be provided for control of the auger 18, and preferably the folding-in and folding-out of the auger assembly 18 about a pivot or hinge 50. A second rocker switch may be provided for control of the discharge chute 20, and preferably the rotation of the chute 20 in a first direction and a second direction. A third rocker switch may be provided for control of the inner door 22, and preferably the opening and closing of the door 22. Accordingly, each rocker switch is provided with a centered-neutral position, and a first side 194 the depression of which engages and sends a signal for a first function, and a second side 196 the depression of which engages and sends a signal for a second function. For example, the first function may be the folding-out of the chute 20, the second function may be folding-in of the chute 20. While three rocker switches are specifically discussed, any number of control elements 188, 190, 192 and types of control elements suitable for control of various components of the grain cart 10 may be acceptable for the purposes provided.

Each control element or rocker switch in the illustrated embodiment is therefore engaged with at least one and preferably two electrical connections on the manifold 26, such that one control element may operate a valve in two directions to control hydraulic fluid flow through the manifold 26 in the ports associated with that valve. Therefore, each control element may be in communication with, or operable connection with two cables (not shown).

The remote control 168 of FIGS. 15-16, as indicated above, includes a control interface 198 which carries one or more control elements 188, 190, 192. The control interface 198 maybe formed of an outer face 200 having the control elements 188, 190, 192 thereon. The control interface 198 may also include a handle 202 or grip, such that it may be gripped by an operator's hand. The grip may include an ergonomic surface 204 for hand comfort and may include a textured portion for enhancing grip. Behind the control interface 198 may be a housing which contains one or more of the functional components or interfaces of the control elements 188, 190, 192 with the cabling. The handle 202 may be connected or removably connected to the cable 164 and may also include a rigid or semi-rigid member 208 for maintaining the cable 164 in a particular orientation at a location near the inlet 210 to the control. The remote control housing and handle 202 may be formed of one or more components either integrally formed or attached by fasteners, adhesives, or the like. The remote control housing and handle 202 may be formed of any suitable material, including but not limited to plastic, metal, composite, and combinations thereof. The facing 200 of control interface 198 may include operational instructions for user ease of operation. While the control is described as a hand-held control, the remote control 168 may be mounted or removably mounted to the towing vehicle 28 or grain cart 10.

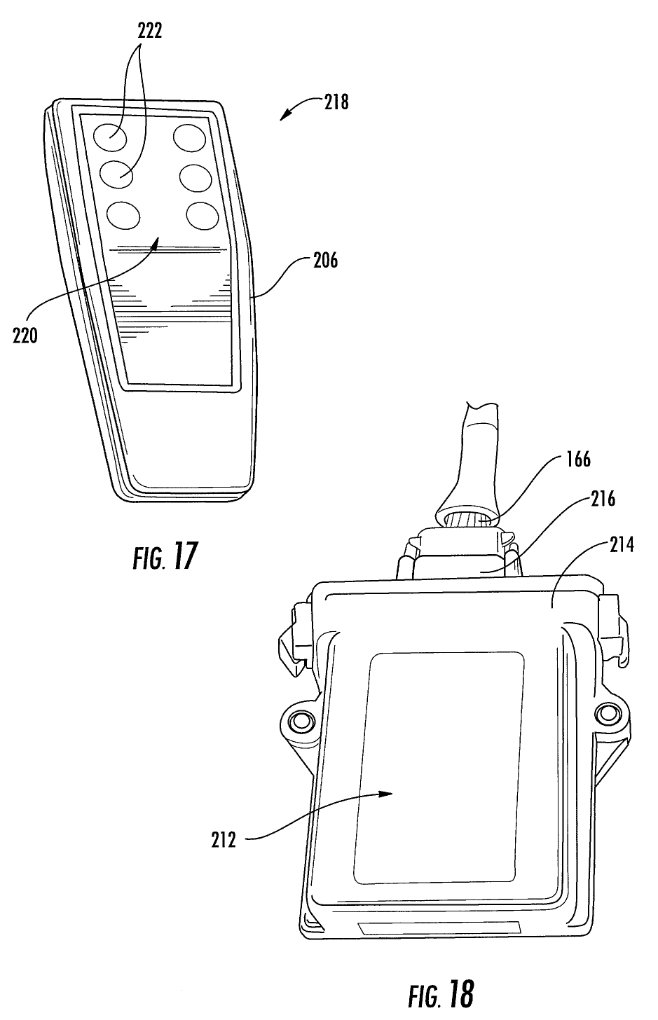

The electrical interface may be a link to or from a wireless connection which receives a wireless signal from a wireless remote (see FIGS. 17-18). In an exemplary embodiment, the wireless connection is formed by a wireless receiver 212 (FIG. 18) which is in communication with the solenoid valves of the assembly. The wireless receiver 212 may be formed of a receiver portion 214 adapted to receive a signal from a transmitter and a manifold connection portion 216. The manifold connection portion 216 of the exemplary embodiment is substantially similar to that described with respect to the pendant control and includes a plurality of plugs 162 adapted to mate with corresponding electrical interfaces on the manifold assembly 26. Alternatively, it is contemplated that the wireless receiver 212 may be formed of a plurality of wireless receivers (not shown) connected to one or more of the electrical interfaces of the solenoids, with or without corresponding plugs 162 and cable 164.

The wireless receiver 212 may receive a signal from any suitable transmission device. The signal may be any suitable signal, including, but not limited to, an RF signal, digital signal, satellite signal, analog signal, or a combination thereof. A suitable wireless receiver 212 may be RE6915hb available from Rowe Electronics of West Des Moines, Iowa. The receiver 212 may preferably be mounted to a portion or surface of the grain cart. The wireless receiver 212 may be mounted to the grain cart 10 in any suitable location, and preferably in a location acceptable for receipt of a wireless signal.

The transmission device may be a remote control 218 adapted to transmit a wireless signal. An exemplary embodiment, shown in FIG. 17, may be a hand-held device. With certain exceptions noted herein, the hand-held device may be substantially as described for remote control 168, including for example, a housing and a control interface. The remote control 218 may also include a handle (not shown). In the illustrated embodiment, the remote control 218 is formed generally of a housing formed similar to that of a hand-held device, such as a commonly used wireless remote control. In an alternative embodiment, the remote control 218 may be mounted or removably mounted to a portion of the grain cart 10 or towing vehicle 28. Similar to the pendant control, the remote control 218 preferably includes a control interface 220 having one or more control elements 222 for operation. Each of the control elements may be formed of a push button or touch screen interface which may be used to communicate the various signals of the control and may be adapted to communicate signals to the receiver 212 based upon the selection of control element. To this end, the control may include a computer or programmable microprocessor, and may be adapted to receive a frequency. A suitable remote control may be RE6915hb available from Rowe Electronics of West Des Moines, Iowa.

In a preferred method of operation, a control or control element of the remote control 168 or 218 is selected and actuated. In response, a signal is sent to the electrical interface of the selected valve on the manifold 26. The valve is selected based upon the chosen control element which sends a signal to the corresponding electrical interface. The electrical signal is converted into mechanical action, wherein the valve is then actuated or operated to direct the flow of hydraulic fluid through the manifold 26. The valve associated with the supply and return lines 34, 36 may also be activated to control flow of hydraulic fluid into and out of the manifold 26. The hydraulic fluid flows through the valve in the manifold 26 and into the now opened circuit of choice based upon the selected valve, which may be to a hydraulic cylinder performing some function, in the preferred embodiment operating at least one of the auger 18, the chute 20, or the door 22. As the hydraulic fluid flows, generally under pressure, to one side of the selected cylinder the ram or the cylinder extends or retracts depending on the selection. Hydraulic fluid from the other side of the cylinder flows back through its line, through the hydraulic manifold 26 and return line 36 and back to the reservoir. When the control is operated for the opposite function, the process is reversed and the hydraulic cylinder actuates in the opposite direction. Accordingly, in a preferred embodiment, operation of the control element for the auger 18 causes the unfolding or folding of the auger 18 about it's pivot or hinge 50. Similarly, operation of the control element for the discharge chute 20 causes the pivotal movement of the chute 20 about the auger tube. Operation of the control element for the inner door 22 causes the opening or closing of the door 22.

Generally, assembly of the system involves obtaining a grain cart 10. The manifold 26 is attached to the grain cart by any suitable means for securing same in place. Hydraulic lines are connected to the manifold and the hydraulic cylinders in the locations described herein. A communication device or remote control is placed in communication with the manifold by forming the electrical connections described herein.

The present invention has significant advantages over traditional devices. For example, the remote control of the operations enhances user safety and comfort in control of the features of the grain cart 10 as the user may hold the remote control in hand and simultaneously operate the control and view the operation of the device. Furthermore, only a single set of hydraulic lines are provided between the towing vehicle 28 and the grain cart 10, providing ease of hook up and operation of the cart. Moreover, the central operation and control of the various functions of the grain cart 10 stemming from a single position on the grain cart 10, and by use of a single controller reduces the number of components in a hydraulic system and steps that must be taken by an operator to operate the moveable devices or connect to the hydraulic system. It should be noted that each operation is labeled on the remote control thereby eliminating confusion between different equipment or operators.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, coupled, connected) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to preferred embodiments, persons skilled in the art will recognize that changes may be made in form and detail without departing from the spirit and scope of the invention.

What is claimed is:

1. A grain cart comprising:
a plurality of moveable devices positioned on the grain cart which are hydraulically controlled;
a manifold mounted to the grain cart and hydraulically connected to more than one of the plurality of moveable devices;
a remote control in communication with the manifold to hydraulically control movement of the moveable devices hydraulically connected to the manifold.

2. The grain cart of claim 1 further comprising a hydraulic connection to a towing vehicle formed by a single hydraulic supply line and a single hydraulic return line extending between the manifold and the towing vehicle.

3. The grain cart of claim 1, wherein the plurality of moveable devices includes a pivoting auger.

4. The grain cart of claim 1, wherein the plurality of moveable devices includes a discharge chute.

5. The grain cart of claim 1, wherein the plurality of moveable devices includes a door on the grain cart.

6. The grain cart of claim 1, wherein each of an auger, a discharge chute and a door are hydraulically connected to the manifold and controllable by the remote control.

7. The grain cart of claim 1, wherein the remote control comprises a cable in communication with the manifold.

8. The grain cart of claim 1, wherein the remote control comprises a wireless transmitter and the manifold is in communication with a wireless receiver.

9. The grain cart of claim 8, wherein the wireless transmitter is an RF transmitter and the wireless receiver is an RF receiver.

10. A remote control for controlling functions of a grain cart comprising:
a control device having a plurality of control elements; and
a communication means for communicating with a manifold carried by the grain cart and hydraulically connected to a plurality of moveable devices carried by the grain cart such that the moveable devices move in response to the operation of at least one control element.

11. The remote control of claim 10, wherein the communication means is a cable operably connected to the manifold and the control interface.

12. The remote control of claim 10, wherein the communication means is a wireless device.

13. The remote control of claim 10, wherein the control device is a hand-held device.

14. The remote control of claim 13, wherein the hand-held device includes a pendant grip.

15. A method of assembling a control assembly for a grain cart comprising:
obtaining a grain cart having a plurality of moveable devices;
attaching a manifold to the grain cart;
connecting hydraulic lines between the manifold and the plurality of moveable devices;
connecting a single hydraulic supply between the manifold and the towing vehicle and a single hydraulic return line between the manifold and a towing vehicle;
placing a communication means in communication with the manifold for control of the plurality of moveable devices.
